(19) United States
(12) Patent Application Publication
(10) Pub. No.: US 2008/0272285 A1
(43) Pub. Date: Nov. 6, 2008

(54) Ion Mobility Spectrometer Comprising a Corona Discharge Ionization Element

(75) Inventors: Roberto Giannantonio, Oleggio NO (IT); Luca Mauri, Bovisio Masciago MI (IT); Marco Urbano, Milano MI (IT); Antonio Bonucci, Milano MI (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SAES GETTERS S.P.A., Lainate MI (IT)

(21) Appl. No.: 10/599,922

(22) PCT Filed: Jul. 18, 2005
(86) PCT No.: PCT/IT05/00409

§ 371 Date: Oct. 13, 2006

(30) Foreign Application Priority Data
Jul. 27, 2004 (IT) MI2004A 001523

(51) Int. Cl. H01J 49/10

(52) U.S. Cl. 250/281

(57) ABSTRACT

An ion mobility spectrometer is disclosed wherein the ionization element is a corona discharge source (300) consisting of: a first chamber (308) provided with an inlet (309) for a gas to be analyzed and with at least one first opening (311) for communication between the internal space of the first chamber and the reaction zone of the spectrometer; a second chamber (303), contained in the first chamber, provided with an inlet (306) for an ultra-pure gas or a mixture of ultra-pure gases, and with at least one second communication opening (310, 310′) between the first and the second chamber; a pair of electrodes (304, 302′), at least one of which (304) is needle-shaped, arranged in the second chamber, with the pair of electrodes and the second opening arranged in such geometrical relationships that there is no optical path between the zone of the corona discharge and the ion detector of the IMS instrument. The instrument of the invention allows to reproduce the results of a spectrometer equipped with a ⁶³Ni ionization source, while avoiding the problems connected to the transportation and use of radioactive material.

The present invention relates to an ion mobility spectrometer comprising a corona discharge ionization element.

The ion mobility spectrometry is also known in the art by the acronym IMS (the same acronym is used also for the instrument whereby the technique is carried out, indicating in that case “Ionization Mobility Spectrometer”). The sample subjected to an IMS analysis is normally a carrier gas comprising the gases or vapors to be analyzed: by operating in suitable conditions quantities in the order of picograms (pg, i.e. 10⁻¹² grams), or concentrations in the order of parts per trillion (ppt, equivalent to a molecule of the analyzed substance every 10¹² molecules of the sample gas) of a gas or vapor can be detected in the carrier gas. The IMS technique is commonly used for the qualitative analysis of species such as explosives or drugs, for example in airports, due to its fast detection of these substances. Among the features that make this technique particularly useful for these purposes there are its very high sensitivity, speed in obtaining results, and limited size and costs of the instrument. IMS instruments and analysis methods in which these are employed are disclosed, e.g. in the U.S. Pat. Nos. 5,420,424, 5,457,316, 5,955,886 and 6,229,143 B1.

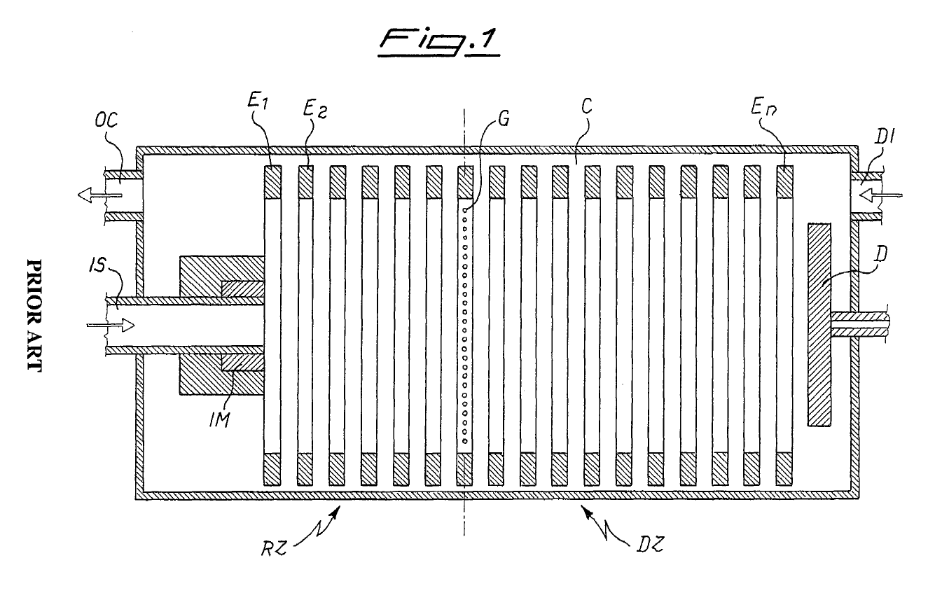

FIG. 1 shows in a cross-sectional view the main elements forming an IMS instrument. The instrument is formed by a chamber C, generally cylindrical, divided in a reaction zone, RZ, and a separation zone, DZ. The chamber C has at one end an inlet IS for the gas to be analyzed and at the opposite end a charged particles detector D (this latter one is connected to the electronics of the instrument, not shown, for collecting the data that will form the IMS spectrum). The chamber C is equipped with two further ports, DI and OC, respectively for the inlet of a gas, known in the field as “drift gas”, and the chamber outlet for the mixture formed by the drift gas and the sample: the drift gas constitutes the gaseous means in which the ions move and that allows their separation. In the drawing the configuration corresponding to the most common operation mode is shown, wherein the direction of motion of the drift gas is opposite to that of the ions, but the ports DI and OC could be inverted in the case in which the drift gas flow is directed in the same direction as the direction of motion of the ions. The sample enters into the chamber C through the ionizing element represented in an extremely schematic form as element IM.

The ionic species formed by the element IM are carried by the gaseous flow and possibly by suitable electric fields into the reaction zone, RZ, wherein the ionic species corresponding to the molecules present in the gas under analysis are formed. Due to the concentration of the molecules of the carrier gas, which is several orders of magnitude higher than that of the other species present, the ionization takes place mainly on account of the said molecules with the formation of the so-called “reactant ions”, whose charge is then distributed on the other species present according to of their electronic or proton affinities or to their ionization potentials. The book “Ion Mobility Spectrometry” by G. A. Eiceman and Z. Karpas, published in 1994 by CRC Press, can be referred to for an illustration of the (rather complex) charge transfer principles which are at the base of the ionization mobility spectrometry technique.

The reaction zone RZ is divided from the separation zone DZ by a grid G which, when electrified, prevents the ions present in the reaction zone RZ from entering the DZ zone; vice versa, when the grid is momentarily deactivated (for times in the order of some hundreds of microseconds), a part of the ions present in the RZ zone can pass into the separation zone DZ (known also as “drift zone”). The ions previously formed in the DZ zone are accelerated toward the detector by a suitable electric field, and at the same time slowed down by the presence of the drift gas; the concomitance of these two opposing effects causes the various ions separation according to the values of their charge, mass and dimension leading to different arrival times (referred in the art as drift times) onto the detector with the consequent formation of charge peaks; by interpreting the spectrum consisting in the totality of these peaks in function of time, through appropriate calibration tests, it is possible to deduct the presence of some species searched for in the sample under examination.

The transport of the ions from one end, where the inlet IS is present, toward the detector D is due to the presence of an electric field generated by electrodes E₁, E₂, . . . , Eₙ.

The ionization of the sample usually takes place by means of beta-radiations emitted from the radioactive nickel isotope ⁶³Ni. The presence of this element gives some safety problems, since a radioactive source obviously can not be “turned off” and always emits ionizing thus potentially dangerous radiations. Because of this characteristic, the storage and the transport of IMS instruments with sources based on ⁶³Ni are ruled by very restrictive international regulations, which make transport and use thereof difficult and burdensome.

One of the solutions proposed to overcome the problem is the substitution of the radioactive source by a corona discharge source. This ionization source consists of two electrodes, one of which is generally needle-shaped, with a gaseous medium interposed between them: applying a suitable potential difference to the two electrodes, a high electric field is generated therebetween, capable of extracting electrons from one of the two electrodes and to accelerate them towards the other one; these electrons, highly energetic, will ionize the gas molecules met along their path.

Ionization sources based on a corona discharge for use in analytical instruments, also of the IMS type, are disclosed e.g. in the U.S. Pat. Nos. 5,420,424, 5,684,300, 6,100,698 and 6,225,623 B1. In the instruments disclosed in these patents the discharge is generated directly in the sample, being formed by a mixture of a carrier gas and traces of gases or vapors the presence of which has to be determined; these instruments are found to be suitable for conventional IMS analysis, wherein, as stated above, the main purpose of the analysis is the qualitative determination of the presence of species such as explosives or drugs.

Recently, however, there has been an increased interest for the use of the technique also for quantitative analysis, and in particular for the analysis of ultra pure gases to be used in the microelectronics industry. Examples of this application are reported in the U.S. Pat. No. 6,740,873 B2 and in the published international patent applications WO 02/052255, WO 02/054058, WO 02/090959, WO 02/090960, WO 02/099405, WO 2004/010131 and WO 2004/027410, all in the name of the applicant, which disclose the use of conventional instruments, equipped with a ⁶³Ni ionization source. As described in these publications, the quantitative IMS analysis is very complex, in particular when the concentration of several impurities simultaneously present in the sample has to be determined, and requires a “fine” knowledge and the control of all parameters coming into play.

A parameter whose control is of fundamental importance in this type of analysis is the quantity of primary ions formed by the electric discharge, equivalent to the ionic current generated directly between the two electrodes of the source. The ionic current depends, apart from the geometrical parameters of the source, on the composition of the gas present between the electrodes. Since, as already said, in the prior art instruments the discharge is generated directly in the sample gas, and since in an actual analysis the composition of the sample gas can fluctuate with time due to possible variations in the type and amount of the gaseous impurities, it is not possible with the instruments of prior art to ensure that the ionic current and thus the quantity of the total charge corresponding to the primary ions are constant; consequently it is impossible to formulate the calculations on how this charge is distributed among the impurities, which is at the basis of the quantitative analysis. The results is, that the IMS instruments equipped with corona discharge sources of the prior art are not suitable for quantitative analysis, particularly of the multi-component type.

The object of the present invention is to overcome the problems of the prior art, and in particular to provide a corona discharge ionization source suitable for the use in quantitative IMS analyses of all impurities being simultaneously present in a gaseous sample.

This and other objects are obtained according to the present invention with an ion mobility spectrometer characterized by comprising, as ionizing element, a corona discharge source consisting of:
a first chamber provided with an inlet for a gas to be analyzed and with at least one first communication opening between the internal space defined by said first chamber and the reaction zone of an IMS spectrometer;
a second chamber, contained in said first chamber, provided with an inlet for an ultra-pure gas or a mixture of ultra-pure gases, and with at least one second communication opening between said first and second chamber;
a pair of electrodes, at least one of which is needle-shaped, arranged in said second chamber;

said pair of electrodes and second opening being arranged in such geometrical relationship that there is no optical path between the zone of the corona discharge and the ion detector of the IMS instrument.

The inventors have found that the above described drawbacks deriving from the use of a corona discharge source in quantitative IMS (mono- or multi-component) analysis can be overcome if the discharge is generated, rather than inside the sample, as previously known, in an ultra-pure gas that can be the same as or different from the carrier gas of the sample. Operating in this way, the intensity of the ionic current (and therefore the quantity of primary ions) generated in the source depends only on the geometry of the pair of electrodes, on the values of gas pressure, temperature and potential difference applied between the electrodes; since the geometry of the electrodes is fixed and therefore constant, by keeping constant the other three cited parameters it is possible to ensure the constancy of the primary ionic current, which as already said is the fundamental requirement for being able to carry out a quantitative analysis with an IMS instrument. In the following description the ultra-pure gas wherein the discharge is generated will also be defined as auxiliary gas; the auxiliary gas could also consist of a mixture of ultra-pure gases which do not interfere with the analysis.

The invention will be further described in detail in the following with reference to the attached drawings, wherein:

FIG. 1 shows a schematic cross-sectional view of an IMS instrument;

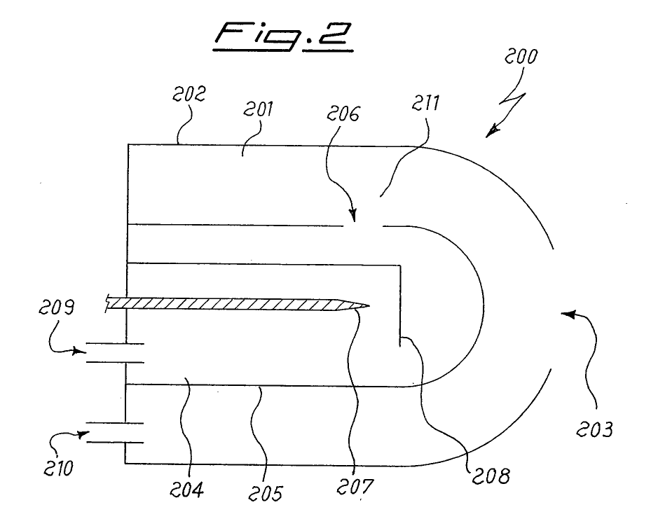

FIG. 2 shows a cross-sectional view of a general embodiment for a corona discharge ionization source according to the invention;

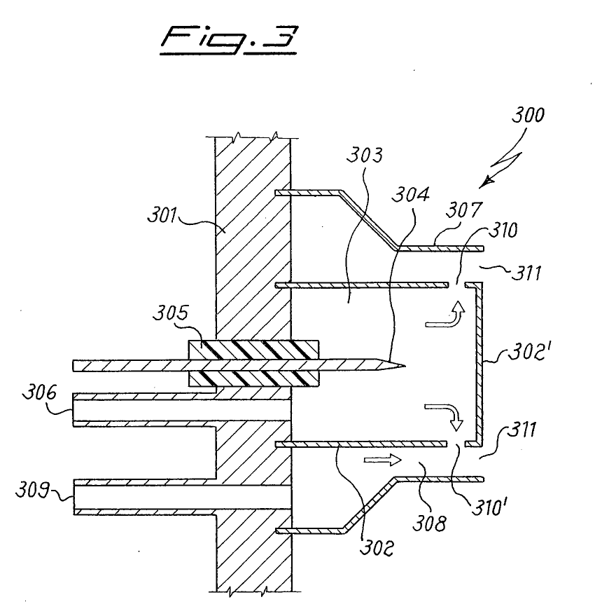

FIG. 3 shows a cross-sectional view of a preferred embodiment of corona discharge ionization source of the invention; and

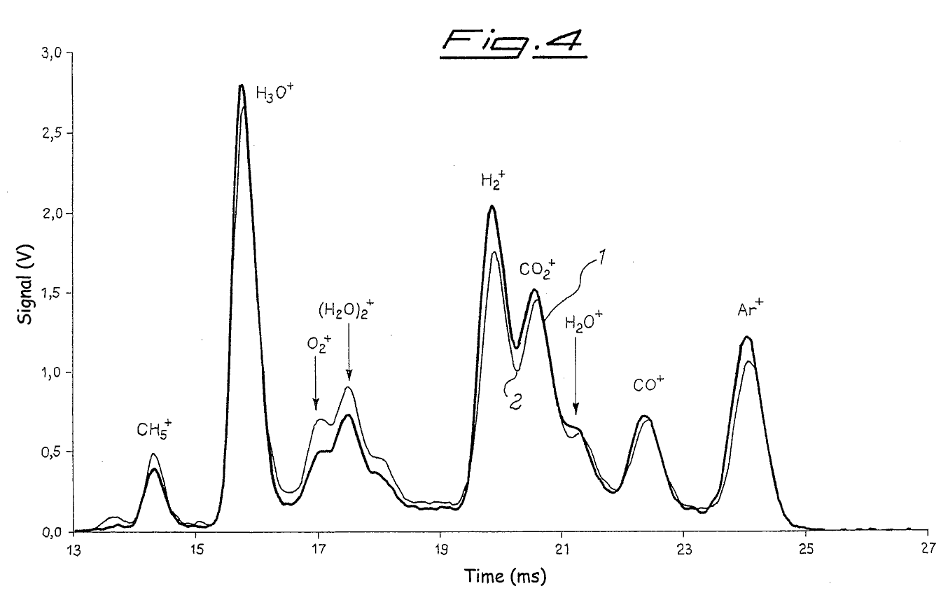

FIG. 4 shows two IMS spectra obtained by operating respectively with an ionization element of the invention and of the prior art.

FIG. 1 has already been previously described. Object of the invention is the substitution of the radioactive ⁶³Ni in the ionization element IM of FIG. 1.

FIG. 2 shows the corona discharge source of the invention in its most general form. The source 200 is formed by: a first chamber, 201, defined by a first wall 202, provided with a first aperture 203 to allow the ions produced in the source to pass into the measuring chamber of the IMS instrument; a second chamber, 204, defined by a second wall 205, provided with at least one second aperture 206 for the passage of the ions produced in the second chamber towards the first chamber; a first needle-shaped electrode 207 and a second electrode 208 (of whatever geometry), arranged in the second chamber; an inlet 209 for the introduction of the auxiliary gas into the second chamber; and an inlet 210 for the introduction of the sample into the first chamber. With this configuration, and by operating with suitable ratios of flow rates and/or pressures between the auxiliary gas and the sample or with adequate ratios between the dimensions of the apertures 203 and 206, it is possible avoid the sample diffusion in chamber 204, so that only the ultra-pure auxiliary gas is present therein, thus ensuring a constant current generation by the primary ions. The primary ions so formed (together with radicals and metastable species) are carried by the motion of the auxiliary gas through the aperture 206 into the zone 211 of the first chamber 201, where the total mixing with the sample takes place; owing to this mixing, the primary ions transfer their charge to the gas molecules present in the sample. Then the mixture of sample, auxiliary gas and ionic species passes through the aperture 203 into the reaction zone RZ of the IMS instrument, where the reactions of charge transfer continue, with the formation of the ionic species corresponding to the impurities to be determined.

The formation of ions in an auxiliary gas by corona discharge was already known from the U.S. Pat. No. 5,485,016; however, this document relates to a mass spectrometer with ionization at atmospheric pressure, and this involves significant differences, both constructive and functional, with respect to the present invention. In the instrument according to the cited patent the ionization takes place in a zone kept at atmospheric pressure, whereas the ions separation zone is under high vacuum. In order to maintain this condition it is necessary to limit as much as possible the passage of the neutral species from the ionization zone to the separation one, this result is obtained by an orifice as small as possible placed between the two, and by the use of a geometry of the electrostatic lenses that maximize the extraction of the ions toward the separation zone; in this geometry necessarily, the needle-shaped electrode, the aperture for the passage of the ions from the discharge chamber to the zone of mixing with the sample, and the aperture for the passage of the ions from said mixing zone to the separation zone of the instrument are aligned along the axis of the instrument. This configuration would present serious drawbacks if adopted in an IMS spectrometer, because in a corona discharge photons are also produced: with an axial geometry of the corona discharge source, the photons would enter into the separation zone of the IMS instrument, generating in said zone ions not deriving from the equilibrium established in the reaction zone; furthermore, the photons would hit the detector generating by photoelectric effect a “spurious” current, read by the instrument as ionic current, reducing the signal/noise ratio of the measurement; the result of these two effects would be to increase the measurement uncertainty.

U.S. Pat. No. 5,218,203 discloses an ionization element that can be used in various analytical instruments, including an IMS. The inlet of the auxiliary gas and of the sample in this case occur through two concentric tubes, with the sample in the inner tube, and there is explained that the two gases must undergo the minimum mixing possible; only the ions produced in the auxiliary gas are directed, by means of a suitable electric filed, through the flow of the sample, for the charge transfer; in order to prevent the sample and the auxiliary gas from mixing, the two gases are introduced into the system in conditions of laminar flow, and to achieve this effect along the inlet line of the gases suitable diffusing means for eliminating turbulences are provided. Vice versa, in the case of the present invention the mixing of the auxiliary gas and of the sample is an essential characteristic to obtain the desired results. Besides, in the cited patent it is said that it is possible to use either a corona discharge source or radioactive sources, but these latter ones are preferred because the corona discharge sources produce, in addition to ions, also radicals and metastable species: these additional ionizing elements are undesirable for the object of the cited patent, wherein the only ionization mechanism is the physical contact of the ions generated in the auxiliary gas with the sample, because the formation of radicals or metastable ions could give rise to unexpected contributions to the ionization of the sample, and consequently to a practical impossibility of performing the analysis. On the contrary, the present invention is directed exclusively to the use of corona discharge sources, moreover in this case the presence of radicals or metastable species does not represent a problem, but can even be exploited to increase the sensitivity of the instrument.

FIG. 3 shows a cross-sectional view of a preferred embodiment of the corona discharge source of the present invention.

In this case the source 300 is assembled directly on the wall 301 forming the end of the chamber C of an IMS instrument such as shown in FIG. 1. An inner wall, made as an essentially cylindrical part 302 and an essentially planar part 302′, forms the second chamber, 303, of the source; in the chamber 303 the needle-shaped electrode 304 is present; the electrode 304 feeds through respect to the wall 301 of the instrument and is connected to the external electronics; the electrode 304 is electrically isolated with respect to the wall of the instrument by means of an insulating element 305, that can be made of plastic, ceramic or vitreous material. In this preferred variant the counter-electrode consists of the wall defining the second chamber and made, at least in the part 302′, of a conducting material electrically connected with the outside. In the wall 301 an aperture for connecting with a conduit 306 is formed, for the inlet of the auxiliary gas into the second chamber 303. A more outer wall, 307, defines, together with the part 302, the first chamber 308. An aperture is formed in the wall 301 for connecting with a conduit 309 for the inlet of the sample gas into the first chamber 308. Part 302 presents, in the area adjacent to part 302′, a series of apertures, 310, 310′, allowing the passage towards the first chamber of the auxiliary gas, ions and other ionizing elements such as radicals and metastable ions formed therein by the discharge (the direction of the flow of the auxiliary gas in this zone is indicated by the bent arrows). The area of the chamber 308 surrounding the aperture 310, 310′, forms the mixing region, wherein the primary ions, radicals and metastable atoms formed by the discharge in the chamber 303 react with the sample and transfer the charge to the gaseous molecules present therein. The chamber 308 has an aperture in the form of a circular corona, 311, for the transfer of the ionized sample into the RZ zone of the IMS instrument. The discrete apertures 310, 310′ can be substituted by a net or a filter, connecting the walls 302 and 302′.

As previously said, according to the present invention it is necessary to prevent that the sample gas present in the first chamber (201; 308) enters into the second chamber (204; 303) to ensure the absence of impurities in this latter; this condition can be accomplished by controlling the flows of the auxiliary gas (F_{A}) and of the sample gas (F_{C}), the respective pressures, and the ratios between the overall dimensions of the apertures between the two chambers (206; 310, 310′) and those of the apertures (203; 311) toward the reaction zone RZ of the IMS instrument. By suitable choices of these parameters, within the reach of the person skilled in the art, it is possible to have a gas flow in such a way that in correspondence with the said apertures between the two chambers it is always oriented from the second (204; 303) to the first (201; 308) of said chambers.

In addition, with the instrument of the invention it is possible, by suitably choosing the potentials of the needle-shaped electrode (207; 304), of the counter-electrode (208; 302′) and of the first electrode of the reaction chamber (E₁), to extract from the source both ions and excited neutral species (radicals and metastable species), or only these latter ones, rendering thus available to the operator a further control parameter for the analysis.

Finally, the corona discharge ionization element of the invention can be used by keeping constant either the potential difference between the electrodes or the current. The first case (constant potential difference) is the most common operation mode. However, with time the electrodes can undergo surface alterations due to e.g. the presence of oxidizing species in the second chamber; these species can be impurities present in the auxiliary gas (even an ultra-pure gas contains always some traces of impurities), or the auxiliary gas as such can be an oxidizing gas or a mixture of gases among which there is an oxidizing one. These chemical surface alterations of the electrodes result in a modification (generally in the sense of decrease) of the current when operating at constant potential difference. Operating at constant current allows to cancel this time drifting effect.

The invention will be further described in the following non-limiting examples. These examples describe some embodiments intended to teach to those skilled in the art how to practice the invention and to show the best considered mode for the realization of the invention. The IMS instrument used for the tests has a geometry such as shown schematically in FIG. 1, with the length of the reaction zone (from the electrode E₁ to the grid-electrode E_{g}) equal to 6 cm and the length of the separation zone (from the electrode E_{g} to the detector D) equal to 8 cm. The electric field applied in the chamber C of the instrument is always equal to 130 V/cm. The opening time of the grid G is 200 microseconds (μs) in both tests. From preliminary indicative tests it was known that under these conditions the drift times of the species present in the tests are generally between 15 and 30 milliseconds (ms). The intensity of the respective peaks of the different species is given in volt (V); the conversion into volt of the electric current measured directly by the detector D is performed by the instrument electronic.

### EXAMPLE 1

An analysis is performed of a helium sample (starting from a blended cylinder supplied by the company SIAD of Bergamo, Italy) having the following nominal composition of impurities: 1±0.1 ppb of water, 1±0.1 ppb of oxygen, 1±0.1 ppb of hydrogen, 1±0.1 ppb of carbon monoxide, 1±0.1 ppb of carbon dioxide and 1±0.1 ppb of methane, using argon as auxiliary gas.

These concentrations are obtained, starting from a certified gas cylinder supplied by SIAD containing about 5 ppm of all the impurities, by means of dilution via calibrated orifices, with ultra pure helium.

The IMS spectrometer is equipped with a corona discharge ionization element IM, of the type illustrated in FIG. 3. In this element, the distance between the tip of the electrode 304 and the electrode 302′ is 2.5 mm; the parts 302 and 302′ are joined by a grid, so that the overall dimension of the apertures between chamber 303 and chamber 308 is equal to 40 mm², while the aperture 311 has a total area of 90 mm². The auxiliary gas is supplied into chamber 303 through the aperture 306, at a pressure of 1050 hPa and with a flow rate of 500 cc/min; the sample gas is supplied into chamber 308 through the aperture 309 at a pressure of 1025 hPa and with a flow rate of 500 cc/min; as drift gas argon is used in counter-flow with respect to the motion of the ions, being let into the IMS chamber through the port DI with a flow rate of 2000 cc/min. Between the electrodes 304 and 302′ a difference of potential of 1800 V is kept, with the electrode 304 at higher potential. In these conditions, Ar⁺ ions, metastable Ar* species and to a lesser extent photons (whose limited contribution is due to the small optical path present between the two chambers) are introduced into the first chamber 308; these species are not able to ionize the carrier gas of the sample, He, whereby the first charge transfer takes place on account of the argon molecules of the auxiliary gas, and subsequently from these to the impurities present in the sample. The spectrum obtained as a result of the test is illustrated in FIG. 4 as curve 1 (curve with a larger thickness). In the graph in the drawing, every peak is attributed to the simplest associate ion, although the species really present in the instrument are generally consisting of these ions variably associated with neutral molecules.

### EXAMPLE 2

### Comparative

The test of example 1 is repeated, keeping all the conditions unchanged except for the ionization of the auxiliary gas which is obtained by the use of a radioactive source of ⁶³Ni with an activity of 10 milliCurie, positioned in chamber 303, without supplying the electrodes 304 and 302′. The resulting spectrum is reported in FIG. 4 as curve 2 (thinner curve in the drawing).

As can be seen from the examination of the two curves in FIG. 4, the use of the corona discharge ionization source of the invention allows to reproduce the spectrum obtained with another sample of the same gas by using a conventional source of ⁶³Ni (the minimal differences between the two spectra are due to slight fluctuations of the composition of the sample in the two successive tests), therefore performing multi-component analyses that are already possible with radioactive sources, but without the problems associated to the use of these latter.

1. An Ion mobility spectrometer comprising a reaction zone, a drift zone and an ion detector, comprising, as ionization element, a corona discharge source (200; 300) comprising:
a first chamber (201; 308) provided with an inlet (210; 309) for a gas to be analyzed and with at least one first opening for communication (203; 311) between the internal space defined by said first chamber and the reaction zone of an IMS spectrometer;
a second chamber (204; 303), contained in said first chamber, provided with an inlet (209; 306) for an ultra-pure gas or a mixture of ultra-pure gases, and with at least one second communication opening (206; 310, 310′) between said first and second chambers; and
a pair of electrodes (207, 208; 304, 302′), at least one of which (207; 304) is needle-shaped, arranged in said second chamber;
said pair of electrodes and second opening being arranged in such geometrical relationship that there is no optical path between the zone of the corona discharge and the ion detector of the IMS instrument.

2. The Ion mobility spectrometer according to claim 1, further comprising an electronic circuit allowing maintenance of a constant potential difference between said pair of electrodes.

3. The Ion mobility spectrometer according to claim 1, further comprising an electronic circuit allowing maintenance of a constant current between said pair of electrodes.
